(19) United States
(12) Patent Application Publication
(10) Pub. No.: US 2026/0002042 A1
(43) Pub. Date: Jan. 1, 2026

(54) REVERSIBLE CROSSLINKED COATING FOR CONDUCTOR AND PROCESS

(71) Applicant: Dow Global Technologies LLC, Midland, MI (US)

(72) Inventors: Michael T. Petr, Trappe, PA (US); Hayley A. Brown, Houston, TX (US); Colin Li Pi Shan, Pearland, TX (US); Jeffrey M. Cogen, Flemington, NJ (US)

(21) Appl. No.: 18/992,459

(22) PCT Filed: Jul. 14, 2023
(86) PCT No.: PCT/US2023/027776

§ 371 Date: Jan. 8, 2025

Related U.S. Application Data
(60) Provisional application No. 63/389,707, filed on Jul. 15, 2022.
(60) Provisional application No. 63/389,738, filed on Jul. 15, 2022.

(51) Int. Cl. C09D 123/06; C09D 7/63

(52) U.S. Cl. CPC C09D 123/06; C09D 7/63

(57) ABSTRACT

The present disclosure is directed to a coated conductor. In an embodiment, the coated conductor includes a conductor and a coating on the conductor. The coating is composed of a crosslinked composition formed from starting materials comprising an ethylene-based polymer, and 2,2,6,6-tetramethyl-4-piperidyl methacrylate disulfide (BiTEMPS) methacrylate. This yields a coating that is composed of a crosslinked composition comprising (i) an ethylene-based polymer, and linkages having a Structure (2).

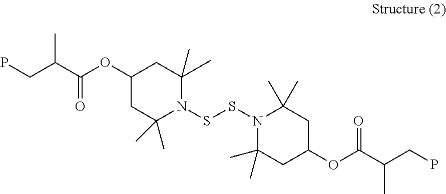

### BACKGROUND

Crosslinked polyethylene (XLPE) is a mainstay material for the insulation layer in power cables. For medium and high voltage cable manufacturing, XLPE is typically produced by extruding melted low density polyethylene (LDPE) with peroxide onto a metal conductor followed by heating the coated conductor to thermally activate the peroxide and initiate free-radical crosslinking of the LDPE. Such peroxide-initiated crosslinking requires energy-intensive post-extrusion processing equipment. Post-extrusion equipment is required to heat the coated conductor upon exit from the extrusion die outlet. Post-extrusion equipment is required to cool the coated conductor from the high crosslinking temperature to ambient temperature. Post-extrusion equipment is required to degas the coated conductor after the coated conductor has cooled in order to remove crosslinking byproducts.

Efforts to replace XLPE with insulation material that is not crosslinked (and thereby reduce equipment costs) have fallen short in delivering a polyethylene that can meet the mechanical and insulative performance of XLPE, as the stresses imparted upon the insulation layer in the power cable environment are substantial. XLPE provides thermomechanical integrity at elevated temperatures. XPLE is able to withstand mechanical stress at service temperature (which may be as high as 90° C. or higher).

The art recognizes the need for crosslinked polyethylene insulation material suitable for use in power cable applications that is reprocessable, reusable, or otherwise recyclable.

### SUMMARY

The present disclosure is directed to a coated conductor. In an embodiment, the coated conductor includes a conductor and a coating on the conductor. The coating is composed of a crosslinked composition formed from starting materials comprising an ethylene-based polymer, and 2,2,6,6-tetramethyl-4-piperidyl methacrylate disulfide (BiTEMPS) methacrylate. This yields a coating that is composed of a crosslinked composition comprising (i) an ethylene-based polymer, and linkages having a Structure (2) below

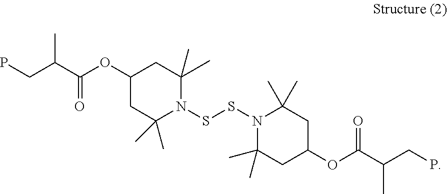

The present disclosure provides a process. In an embodiment, the process includes providing a coating from a coated conductor. The coating is composed of a crosslinked composition composed of (i) an ethylene-based polymer, and (ii) linkages having a Structure (2)

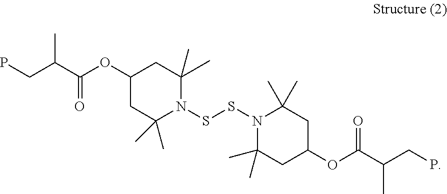

The coating is formed from starting materials of the ethylene-based polymer and 2,2,6,6-tetramethyl-4-piperidyl methacrylate disulfide (BiTEMPS) methacrylate. The process includes heating the coating to a reprocessing temperature, and forming, at the reprocessing temperature, the coating into a re-processable ethylene-based polymer composition. The process includes shaping, at the reprocessing temperature, the re-processable ethylene-based composition into a re-processed pre-form. The process includes cooling the re-processed pre-form to below the reprocessing temperature and forming a second article composed of a re-crosslinked ethylene-based polymer composition composed of (i) the ethylene-based polymer and (ii) linkages having the Structure (2).

### Definitions

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes subranges from 1 to 2; from 2 to 6; from 5 to 7; from 3 to 7; from 5 to 6; etc.).

Unless stated to the contrary, implicit from the context, or customary in the art, all parts and percentages are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

A “conductor” is one or more wire(s), or one or more fiber(s), for conducting heat, light, and/or electricity at any voltage (DC, AC, or transient). The conductor may be a single-wire/fiber or a multi-wire/fiber and may be in strand form or in tubular form. Nonlimiting examples of suitable conductors include carbon and various metals, such as silver, gold, copper, and aluminum. The conductor may also be optical fiber made from either glass or plastic. The conductor may or may not be covered in a protective sheath. The conductor may be a single cable, or a plurality of cables bound together (i.e., a cable core, or a core). “Cable” and “power cable” refer to at least one conductor within a sheath. A “wire” refers to a single strand of conductive metal, e.g., copper or aluminum, or a single strand of optical fiber. Typically, a cable is two or more wires or optical fibers bound together, often in a common insulation covering and/or protective jacket. The individual wires or fibers inside the sheath may be bare, covered or insulated. Combination cables may contain both electrical wires and optical fibers. When the cable is a power cable, the cable can be designed for low, medium, and/or high voltage applications. When the cable is a telecommunication cable, the cable can be designed for telephone, local area network (LAN)/data, coaxial CATV, coaxial RF cable or a fiber optic cable.

An “ethylene-based polymer” is a polymer that contains more than 50 mol % polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), ethylene/α-olefin multi-block copolymers (also known as olefin block copolymer (OBC)), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or multiple reactor configurations.

“Ethylene plastomers/elastomers” are substantially linear, or linear, ethylene/α-olefin interpolymers containing homogeneous short-chain branching distribution comprising units derived from ethylene and units derived from at least one C₃-C₁₀ α-olefin comonomer. Ethylene plastomers/elastomers have a density from 0.854 g/cc to 0.920 g/cc. Nonlimiting examples of ethylene plastomers/elastomers include AFFINITY™ Polyolefin Plastomers and ENGAGE™ Polyolefin Elastomers (available from The Dow Chemical Company), EXACT™ Plastomers (available from ExxonMobil Chemical), Tafmer™ Alpha-olefin copolymers (available from Mitsui), Solumer™ Polyolefin Elastomers and Supreme™ Polyolefin Plastomers (available from SK Chemicals Co.), and Lucene™ Polyolefin Elastomers (available from LG Chem Ltd.).

“High density polyethylene” (or “HDPE”) is an ethylene homopolymer or an ethylene/α-olefin copolymer with at least one C₄-C₁₀ α-olefin comonomer, or C₄-C₈ α-olefin comonomer and a density from 0.940 g/cc, or 0.945 g/cc, or 0.950 g/cc, or 0.953 g/cc to 0.955 g/cc, or 0.960 g/cc, or 0.965 g/cc, or 0.970 g/cc, or 0.975 g/cc, or 0.980 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

The term “linear low density polyethylene,” (or “LLDPE”) as used herein, refers to a linear ethylene/α-olefin copolymer containing heterogeneous short-chain branching distribution comprising units derived from ethylene and units derived from at least one C₃-C₁₀ α-olefin, or C₄-C₈ α-olefin comonomer. LLDPE is characterized by little, if any, long chain branching, in contrast to conventional LDPE. LLDPE has a density from 0.910 g/cc to less than 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

The term “low density polyethylene” (or “LDPE”) may also be referred to as “high pressure ethylene polymer” or “highly branched polyethylene” and is an ethylene homopolymer and is typically produced by way of high pressure free radical polymerization ((≥100 MPa (for example, 100-400 MPa), tubular reactor or autoclave reactor with free radical initiator). LDPE resins typically have a density in the range from 0.915 g/cc to less than 0.940 g/cc. LDPE is distinct from LLDPE.

A “jacket” is an outermost coating on the conductor. When the conductor includes a single coating, the coating may serve as both a jacket and an insulation on the conductor.

An “olefin-based polymer,” or “polyolefin,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “sheath” is a generic term and when used in relation to cables, it includes insulation coverings or layers, protective jackets, and the like.

### Test Methods

Density was measured in accordance with ASTM D792 with results reported in g/cc at 25° C.

Dielectric constant. Dielectric Constant was measured with a Guideline High Voltage Capacitance Bridge at temperatures from 23-130° C. at 2,000V on nominally 50 mil plaques according to ASTM D150-22.

Dissipation Factor. Dissipation factor was measured with a Guideline High Voltage Capacitance Bridge at temperatures from 23-130° C. at 2,000V on nominally 50 mil plaques according to ASTM D150-22. Results are reported in radians.

Mechanical properties, (shear storage and loss moduli (G′ and G″)), were measured on an ARES strain controlled oscillatory shear rheometer with a 1 inch diameter parallel plate fixture, from 10⁻¹-10² radians per second (rad/s), at 0.25% strain, and at both 130° C. and 180° C. on nominally 75 mil think plaques. Tan δ is the ratio of G″ to G′.

Melt index (MI or I₂) (for ethylene-based polymers) is measured in accordance with ASTM D 1238, Condition 190° C./2.16 kg with results reported in grams per 10 minutes (g/10 min).

Rheology analysis was performed using a Rubber Process Analyzer (RPA). Rheology of the compositions was measured using a rotorless oscillating shear rheometer, Alpha Technologies RPA 2000 instrument, according to ASTM D6204, under the following test conditions and exceptions. The sample was placed between two pieces of Mylar film for analysis. Rheology was monitored during an initial timed test at 180° C., 1.0 rad/s, 7% strain, for 60 min. Elastic torque, S′, at the end of the 60 minutes (min) crosslinking step was recorded. Immediately following the 60 min at 160° C., a frequency sweep from 0.1 to 300 rad/s was conducted at 180° C., 7% strain on the same sample, followed by a frequency sweep from 0.1 to 300 rad/s at 190° C., 7% strain, and followed by a frequency sweep from 0.1 to 300 rad/s at 230° C., 7% strain. The dynamic complex viscosity, n*, and tan delta were recorded for each frequency sweep. In ASTM D6204, frequency sweeps on unvulcanized rubber are conducted prior to a cure step. In this case, frequency sweeps were conducted after the initial crosslinking step at 180° C. to evaluate the reversibility of the crosslinking.

Volume resistivity was measured with a Hewlett-Packard High Resistance Meter at 23° C. and 500V on nominally 50 mil plaques according to ASTM D257-14. Results are reported in ohms per centimeter (ohm/cm).

### DETAILED DESCRIPTION

The present disclosure provides a coated conductor. The coated conductor includes a conductor and a coating on the conductor. The coating is composed of a crosslinked composition formed from starting materials comprising (i) an ethylene-based polymer, 2,2,6,6-tetramethyl-4-piperidyl methacrylate disulfide (BiTEMPS methacrylate), and optionally an additive.

### A. Coated Conductor

The coating is located on the conductor. The coating may be one or more inner layers such as an insulating layer. The coating may wholly or partially cover or otherwise surround or encase the conductor. The coating may be the sole component surrounding the conductor. When the coating is the sole component surrounding the conductor, the coating may serve as a jacket and/or an insulation. In an embodiment, the coating is an insulation layer on the coated conductor. Alternatively, the coating may be the outermost layer, such as a jacket or a sheath encasing the conductor (and inner insulation layers).

In an embodiment, the coating directly contacts the conductor. The term “directly contacts,” as used herein, is a coating configuration whereby the coating is located immediately adjacent to the conductor, the coating touches the conductor, and no intervening layers, no intervening coatings, and/or no intervening structures, are present between the coating and the conductor.

Alternatively, the coating indirectly contacts the conductor. The term “indirectly contacts,” as used herein, is a coating configuration whereby an intervening layer, an intervening coating, or an intervening structure, is present between the coating and the conductor. Nonlimiting examples of suitable intervening layers, intervening coatings, and intervening structures include insulation layers, moisture barrier layers, buffer tubes, and combinations thereof. Nonlimiting examples of suitable insulation layers include foamed insulation layers, thermoplastic insulation layers, crosslinked insulation layers, and combinations thereof. In another embodiment, the coating indirectly contacts the conductor, the coating is in indirect contact with an insulation layer, or a semi-conductive layer surrounds the conductor.

### B. Ethylene-Based Polymer

The coating is formed from a crosslinkable polymer composition (interchangeably referred to as “starting materials”) that includes an ethylene-based polymer. The ethylene-based polymer can be an ethylene homopolymer, an ethylene/C₃-C₁₀ α-olefin copolymer, or an ethylene C₄-C₈ α-olefin copolymer. The ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. Nonlimiting examples of suitable ethylene-based polymer include high density polyethylene (HDPE), linear low density polyethylene (LLDPE), low density polyethylene (LDPE), and combinations thereof.

In an embodiment, the ethylene-based polymer is an LDPE ethylene homopolymer and has one, some, or all of the following properties:
a density from 0.910 g/cc to 0.940 g/cc, or from 0.912 g/cc to 0.935 g/cc; and/or
a melt index (MI) from 0.1 to 100. Nonlimiting examples of suitable LDPE include those made from autoclave or tubular process technology. One preferred polymer is a high pressure low density polyethylene (LDPE). The high pressure processes are typically free radical initiated polymerizations conducted in a tubular reactor or a stirred autoclave. In the stirred autoclave, the pressure is in the range of 10,000 to 30,000 psi (70 to 210 kPa) and the temperature is in the range of 175 to 250° C., and in the tubular reactor, the pressure is in the range of 25,000 to 45,000 psi (170 to 310 kPa) and the temperature is in the range of 200 to 350° C.

### C. Free Radical Initiator

The crosslinkable polymer composition from which the coating is formed includes a free radical initiator. In an embodiment, the free radical initiator is an organic peroxide. Nonlimiting examples of suitable organic peroxide include bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1-dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(α-t-butyl-peroxyisopropyl)benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; di(isopropylcumyl) peroxide; dicumyl peroxide, and combinations thereof.

In an embodiment the free radical initiator is dicumyl peroxide.

In some embodiments the crosslinkable polymer composition from which the coating is formed includes a cure package comprising a free radical initiator and, optionally, a coagent. Examples of the free radical initiator include dicumyl peroxide; bis(alpha-t-butyl-peroxyisopropyl)benzene; isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy) 3,3,5-trimethylcyclohexane; isopropylcumyl cumylperoxide; di(isopropylcumyl) peroxide; and mixtures of two or more such initiators. Free radical initiators are used typically in amounts of 0.1 to 3, more typically 0.5 to 3 and even more typically 1 to 2.5, wt % based on the weight of the composition. Various curing coagents (as well as boosters or retarders) can be used in combination with the peroxide initiator, and these include triallyl isocyanurate; ethoxylated bisphenol A dimethacrylate; α-methyl styrene dimer (AMSD); and the other co-agents described in U.S. Pat. Nos. 5,346,961 and 4,018,852. Coagents are used, if used at all, typically in amounts of greater than 0 (e.g., 0.01) to 3, more typically 0.1 to 0.5 and even more typically 0.2 to 0.4, wt % based on the weight of the composition.

### D. BiTEMPS Methacrylate

The crosslinkable polymer composition from which the coating is formed includes 2,2,6,6-tetramethyl-4-piperidyl methacrylate disulfide, interchangeably referred to as “BiTEMPS methacrylate,” or “BiTEMPS” or “BIT.” BiTEMPS methacrylate disulfide has the Structure 1 below.

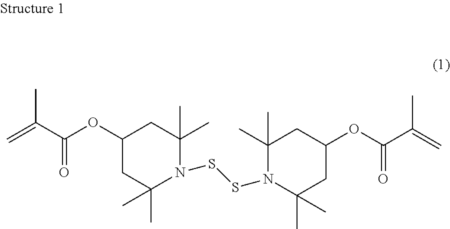 [SMILES: C=C(C)C(=O)OC1CC(C)(C)N(SSN2C(C)(C)CC(OC(=O)C(=C)C)CC2(C)C)C(C)(C)C1]

In an embodiment, the crosslinkable polymer composition includes
from 70 wt % to 98.5 wt %, or from 77 wt % to 98.5 wt % of the ethylene-based polymer;
from 0.1 wt % to 10 wt %, or from 0.1 wt % to 5 wt % 0.1 wt % to 3.0 wt % or from 0.1 wt % to 1.5 wt %, or from 0.5 wt % to 1.5 wt % free radical initiator that is an organic peroxide (such as dicumyl peroxide for example); and
from 1 wt % to 20 wt %, or from 1 wt % to 15 wt %, or from 2 wt % to 20 wt %, or from 2 wt % to 10 wt % BiTEMPS methacrylate. It is understood that the aggregate of the ethylene-based polymer, the free radical initiator, and the BiTEMPS methacrylate disulfide (and optional additives) amount to 100 wt % of the crosslinkable polymer composition.

The crosslinked composition of the conductor coating is formed from the crosslinkable polymer composition. The crosslinkable polymer composition is melt blended at a temperature from 100° C. to 250° C., or from 120° C. to 210° C., or from 140° C. to 210° C., or from 140° C. to 190° C. to trigger the crosslinking reaction and form the crosslinked composition. In an embodiment, the crosslinked composition includes an ethylene-based polymer and 2,2,6,6-tetramethyl-4-piperidyl methacrylate disulfide (BiTEMPS methacrylate). The crosslinked composition contains disulfide linkages formed from the BiTEMPS methacrylate by way of the crosslinking reaction, the disulfide linkages having the Structure 2 below.

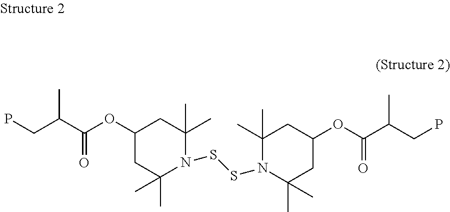

The term (and structure) “P” in Structure 2 above refers to the chain of polymerized ethylene (and optional comonomer(s)) for the ethylene-based polymer. The ethylene-based polymer of the crosslinked composition can be any ethylene-based polymer with a MI from 0.1 g/10 min to 100 g/10 min as previously disclosed herein. Nonlimiting examples of suitable ethylene-based polymer include ethylene/α-olefin interpolymers, high density polyethylene (HDPE), linear low density polyethylene (LLDPE), low density polyethylene (LDPE), and combinations thereof.

In an embodiment, the ethylene-based polymer is a virgin ethylene-based polymer. A “virgin ethylene-based polymer,” as used herein, is an ethylene-based polymer that has not been subjected to a crosslinking reaction. In other words, the term “virgin ethylene-based polymer” refers to the ethylene-based polymer that is present in the crosslinked composition prior to the ethylene-based polymer being crosslinked with the BiTEMPS methacrylate. The virgin ethylene-based polymer is the ethylene-based polymer prior to crosslinking, the crosslinked composition containing the same ethylene-based polymer that was virgin but is now crosslinked with BiTEMPS methacrylate. In this way, the virgin ethylene-based polymer serves as a baseline to evaluate the properties of the crosslinked composition. The crosslinked composition has
(i) a shear storage modulus value, G′, at 130° C. that is greater than the storage modulus value, G′, for the virgin ethylene-based polymer at 130° C.;
(ii) a tan delta value at 130° C. that is less than the tan delta value of the virgin ethylene-based polymer at 130° C.,
and is formed into the coating as disclosed above.

In an embodiment, the crosslinked composition includes from 80 wt % to 97 wt % of the ethylene-based polymer and from 2 wt % to 20 wt % BiTEMPS methacrylate, the aggregate of the ethylene-based polymer and the BiTEMPS methacrylate (and optional additives) amounting to 100 wt % of the crosslinked composition. The crosslinked composition in the coating has
(i) a shear storage modulus value, G′, at 130° C. and 100 rad/s greater than 100 kPa;
(ii) a shear storage modulus value, G′, at 130° C. and 0.1 rad/s greater than 10 kPa; and
(iii) a tan delta value at 130° C. less than 0.60.

### E. Blend Component

In an embodiment, the crosslinkable polymer composition and/or the crosslinked composition includes a blend component. Nonlimiting examples of suitable blend components include ethylene vinyl acetate (EVA), polyolefins (e.g., polyethylene other than the ethylene-based polymer crosslinked with BiTEMPS methacrylate and polypropylene), polymers (e.g., polystyrene, ABS, SBS and the like) and combinations thereof. Non-limiting examples of suitable polyolefins include polyethylene; polypropylene; polybutylene (e.g., polybutene-1); polypentene-1; polyhexene-1; polyoctene-1; polydecene-1; poly-3-methylbutene-1; poly-4-methylpentene-I; polyisoprene; polybutadiene; poly-1,5-hexadiene; interpolymers derived from olefins; interpolymers derived from olefins and other polymers such as polyvinyl chloride, polystyrene, polyurethane, and the like; and mixtures thereof.

Other examples of suitable blend components include functionalized ethylene-based polymers which include an ethylene-based polymer composed of (i) ethylene monomer, (ii) a comonomer that contains a heteroatom, and (iii) an optional termonomer (that may or may not contain a heteroatom). Nonlimiting examples of comonomers with a heteroatom include carbon monoxide, carboxylic acids, esters, alkyl acrylates having 1 to 30 carbon atoms, methacrylate esters having 1 to 30 carbon atoms, vinyl siloxanes having 1 to 16 carbon atoms and halogens. Nonlimiting examples of suitable functionalized ethylene-based polymer include ethylene/carboxylic acid copolymer and metal-salt partially neutralized ionomers derived thereof, ethylene/acrylic acid copolymer (EAA), ethylene/methacrylic acid copolymer (EMAA), ethylene/vinyl(trimethoxy)silane copolymer (EVTMS), ethylene/vinyl acetate copolymer (EVA), ethylene/methyl acrylate (EMA), ethylene/ethyl acrylate copolymer (EEA), ethylene/butyl acrylate copolymer (EBA), ethylene/carbon monoxide (ECO), ethylene/glycidyl methacrylate (E/GMA), ethylene/methyl methacrylate copolymer, ethylene/butyl methacrylate copolymer, ethylene/stearylacrylate copolymer, ethylene/stearylmethacrylate copolymer, ethylene/octylacrylate copolymer, ethylene/2-ethylhexylacrylate copolymer, ethylene/dodecylacrylate copolymer, polyvinyldichloride (PVCD), ethylene/maleic anhydride copolymer (EMAH), polyvinylchloride (PVC), and combinations thereof. Additional nonlimiting terpolymer examples include ethylene/carboxylic acid/acrylate terpolymers and metal-salt partially neutralized ionomers derived thereof, ethylene/methyl acrylate/vinyl(trimethoxy)silane terpolymer copolymer (EMAVTMS), ethylene/ethyl acrylate/vinyl(trimethoxy)silane terpolymer copolymer (EEAVTMS), ethylene/butyl acrylate/vinyl(trimethoxy)silane terpolymer copolymer (EBAVTMS), ethylene/methyl acrylate/glycidyl methacrylate (EMAGMA) ethylene/butyl acrylate/glycidyl methacrylate (EBAGMA), ethylene/vinyl acetate/maleic anhydride terpolymer (EEAMAH), and ethylene ethyl acrylate/maleic anhydride (EEAMAH) terpolymer.

In an embodiment, the polyolefin is a homopolymer such as polyethylene, polypropylene, polybutylene, polypentene-1, poly-3-methylbutene-1, poly-4-methylpentene-1, polyisoprene, polybutadiene, poly-1,5-hexadiene, polyhexene-1, polyoctene-1 and polydecene-1.

Nonlimiting examples of suitable polyethylenes as blend components (other than the ethylene-based polymer that is crosslinked with BITEMPS methacrylate) include ultra low density polyethylene (ULDPE), linear low density polyethylene (LLDPE), low density polyethylene (LDPE), medium density polyethylene (MDPE), high density polyethylene (HDPE), high molecular weight high density polyethylene (HMW-HDPE), ultra high molecular weight polyethylene (UHMW-PE) and combinations thereof. Nonlimiting examples of polypropylene include low density polypropylene (LDPP), high density polypropylene (HDPP), high-melt strength polypropylene (HMS-PP) and combination thereof. In an embodiment, the blend component is a high-melt-strength polypropylene (HMS-PP), a low density polyethylene (LDPE) or a combination thereof.

### F. Additives

The crosslinkable polymer composition and/or the crosslinked composition may contain one or more optional additives. Nonlimiting examples of suitable additives include grafting initiators, cross-linking catalysts, blowing agents, blowing agent activators (e.g., zinc oxide, zinc stearate and the like), coagents (e.g., triallyl cyanurate), plasticizers, processing oils, processing aids, carbon black, colorants or pigments, stability control agents, nucleating agents, fillers, antioxidants, acid scavengers, ultraviolet (UV) stabilizers, flame retardants, lubricants, processing aids, extrusion aids, and combinations thereof. When present, the total amount of additives can be from greater than 0 to 80%, or from 0.001% to 70%, or from 0.01% to 60%, or from 0.1% to 50%, or from 0.1% to 40%, or from 0.1% to 20%, or from 0.1% to 10%, or from 0.1% to 5% of the total weight of the composition. Examples of fillers include but are not limited to clays, precipitated silica and silicates, fumed silica, calcium carbonate, ground minerals, and carbon blacks with typical arithmetic mean particle sizes larger than 15 nanometers.

BiTEMPS methacrylate is a “dynamic crosslinker.” The dynamic crosslinker BiTEMPS methacrylate enables formation of a crosslinked network with the ethylene-based polymer by way of disulfide linkages between the chains of the ethylene-based polymer (in the presence of the free radical initiator) to form the crosslinked ethylene-based polymer composition. The crosslinking is dynamic because the disulfide linkages may be broken, allowing for chain mobility and exchange when the crosslinked ethylene-based polymer composition is subjected to a “reprocessing temperature,” the reprocessing temperature being a temperature from 160° C. to 230° C., or from 160° C. to 200° C. At the reprocessing temperature, the disulfide linkages in the crosslinked ethylene-based polymer composition are broken, forming a re-processable ethylene-based polymer composition. Cooling the re-processable ethylene-based composition below the reprocessing temperature forms a re-crosslinked ethylene-based polymer composition.

The dynamic crosslinker BiTEMPS methacrylate enables a cyclic “reprocessing” for fabrication of new polymeric articles. When the crosslinked ethylene-based polymer composition is heated to the reprocessing temperature, the disulfide linkages break, or otherwise cleave, enabling the previously-crosslinked ethylene-based polymer composition to flow at the reprocessing temperature, forming “a re-processable ethylene-based polymer composition.” Heating to the reprocessing temperature enables crosslink breaking and polymer chain flow, allowing the ethylene-based composition to be reshaped readily. At the reprocessing temperature, the reprocessable ethylene-based polymer composition is no longer crosslinked, but rather is flowable, enabling shaping and/or fabrication of the now flowable reprocessable ethylene-based composition (with BiTEMPS methacrylate) into a new pre-form or article. Upon cooling to below the “reprocessing temperature,” the disulfide linkages form again, the network is re-established, and the re-crosslinked ethylene-based compositions is formed in the new article configuration with a return to the high viscosity (no flow at room temperature) and resistance to mechanical deformation indicative of the crosslinked network. When the newly-formed article of the reprocessable ethylene-based polymer composition is cooled below the reprocessing temperature, the disulfide linkages in the re-processable ethylene-based polymer composition are re-established, and the ethylene-based polymer (with BiTEMPS methacrylate) becomes a re-crosslinked ethylene-based polymer composition in the shape of the newly-fabricated article. Below the reprocessing temperature, the network disulfide linkages are stable, and the re-crosslinked ethylene-based polymer composition exhibits the high viscosity and resistance to mechanical deformation indicative of a crosslinked network. This cycle of crosslink/reprocess/re-crosslink and fabrication into a new article can be repeated.

Bounded by no particular theory, the number of “reprocessing” cycles that are possible with the present crosslinked ethylene-based composition (before competitive thermal and oxidative permanent crosslinking occur and prevent further reprocessing), can be determined by calculating the ratio of the melt viscosity of the crosslinked ethylene-based polymer composition before and after a reprocessing cycle. For the crosslinked ethylene-based polymer composition to be re-processable, the ratio of the viscosity after reprocessing to the viscosity before reprocessing is from 0.5 to 5, or from 0.7 to 3 or from 0.9 to 2 or from 0.95 to 1.2.

Other metrics for monitoring the number of “reprocessing” cycles that are possible with the BiTEMPS methacrylate dynamic crosslinker before competitive oxidative permanent crosslinking occurs include visual observation. A formed film that is mechanically deformed is heated to the reprocessing temperature and is visually inspected to determine whether the mechanically deformed film heals to form a stable film.

The coating may be formed by way of melt blending. “Melt blending” is a process whereby at least two components (i.e., the components of the crosslinkable polymer composition: the ethylene-based polymer, the peroxide, the BiTEMPS methacrylate, and optional additive) are combined or otherwise mixed together, and at least one of the components (the ethylene-based polymer) is in a melted state. The melt blending may be accomplished by way of batch mixing, extrusion blending, extrusion molding, and any combination thereof.

In an embodiment, the crosslinkable polymer composition is extruded over the conductor to form the coating. The extruder has a crosshead die, which provides the desired layer (wall or coating) thickness. A nonlimiting example of an extruder, which can be used is the single screw type modified with a crosshead die, cooling through and continuous take-up equipment. A typical single screw type extruder can be described as one having a hopper at its upstream end and a die at its downstream end. The hopper feeds into the barrel, which contains a screw. At the downstream end, between the end of the screw and the die are a screen pack and a breaker plate. The screw portion of the extruder is considered to be divided up into three sections, the feed section, the compression section, and the metering section, and multiple heating zones from the rear heating zone to the front heating zone with the multiple sections running from upstream to downstream. The length to diameter ratio of the barrel is from 16:1 to 30:1. Grooved barrel extruders or twin screw extruders can also be employed in the core coating process. The extrusion process can take place at temperatures in the range from 80° C., or 100° C., or 120° C., or 140° C., or 160° C., or 180° C., or 200° C. or 220° C., or 240° C., or 260° C. The crosshead die distributes the melt-blended crosslinkable polymer composition in a flow channel such that the melted crosslinkable polymer composition exits with a uniform velocity and is applied to the conductor. In this way, the blending (melt blending) and the extrusion are performed in the same, single extruder. The conductor passes through the center of the crosshead, and as it exits, a uniform layer of the melted crosslinkable polymer composition is circumferentially applied using either pressure, or semi-pressure of tube-on tooling.

One or more layers of the crosslinkable polymer composition can be applied as corresponding one or more coating layers using a multiple crosshead. The conductor (with melted crosslinkable polymer composition thereon, hereafter interchangeably referred to as “the core”) continues to move through the molding passage to outside the die, and then the core is cooled to harden the crosslinkable polymer composition (optionally by passing the core through a water trough) sufficiently to prevent deformation of the applied crosslinkable polymer composition as coating layer on a take-up reel, yielding the coated conductor, the coating composed of the crosslinked composition.

In an embodiment, the coating is an insulation layer on the conductor and the coating is composed solely of the crosslinked composition, and the crosslinked composition comprises, consists essentially of, or consists of:
(i) from 80 wt % to 99.9 wt %, or from 83 wt % to 97 wt % of the ethylene-based polymer;
(ii) linkages of Structure 2 (formed from 1 wt % to 15 wt %, or from 3 wt % of the BiTEMPS methacrylate);
(iii) 0 wt %, or from 0.1 wt % to 10 wt %, or from 0.1 wt % to 5 wt % of a free radical initiator;
(iv) 0 wt %, or from 0.1 wt % to 1.0 wt %, or from 0.1 wt % to 0.5 wt % of an additive,
the aggregate of the ethylene-based polymer and linkages of Structure 2 (formed the BiTEMPS methacrylate) (and optional additives) amounting to 100 wt % of the crosslinked composition.

In an embodiment, the coated conductor includes a coating composed solely of the crosslinked composition, the crosslinked composition comprising, consisting essentially of, or consisting of:
(i) from 80 wt % to 99.9 wt %, or from 83 to 97 wt % an ethylene-based polymer that is an LDPE ethylene homopolymer, the ethylene homopolymer having
   (a) a density from 0.910 g/cc to 0.940 g/cc, and/or
   (b) a melt index from 0.1 g/10 min to 100 g/10 min,
(ii) linkages of Structure 2 (formed from 0.5 wt % to 15 wt %, or from 2.0 wt % to 15 wt % of the BiTEMPS methacrylate);
(iii) from 0 wt %, or from 0.1 wt % to 0.5 wt % of an additive that is an antioxidant, and
the crosslinked composition has one, some, or all of the following properties:
(iv) a degassed volume resistivity at 23° C. from 10¹⁶ ohm/cm to 10²⁰ ohm/cm, and/or
(v) a non-degassed volume resistivity at 23° C. from 10¹⁵ ohm/cm to 10²⁰ ohm/cm, and/or
(vi) a dielectric constant at 23° C. from 2.20 to 2.70, and/or
(vii) a dielectric constant at 110° C. from 1.80 to 2.10, and/or
(viii) a dissipation factor at 23° C. and 60 Hz from 0.0001 radians to 0.01 radians, and/or
(ix) a dissipation factor at 110° C. and 60 Hz from 0.0001 radians to 0.01 radians, and/or
(x) a G′ at 130° C. and 100 rad/s from 10⁵ Pa to 10⁷ Pa, and/or
(xi) a G′ at 130° C. and 100 rad/s from 10⁴ Pa to 10⁷ Pa, and/or
(xii) a tan delta at 130° C. from 0 to 0.6.

In an embodiment, the coating contains carbon black, and the coating is a semiconductive layer on a conductor.

In an embodiment, the coated conductor is selected from a fiber optic cable, a communications cable (such as a telephone cable, a local area network (LAN) cable, or a small form-factor pluggable (SFP) cable), a power cable, wiring for consumer electronics, a power charger wire for cell phones and/or computers, computer data cords, power cords, appliance wiring material, home interior wiring material, consumer electronic accessory cords, and any combination thereof.

The coating composed of the crosslinked composition may comprise two or more embodiments disclosed herein.

### G. Process

The present disclosure provides a process. In an embodiment, the process includes providing a coating from a coating conductor. The coating is a crosslinked composition composed of (i) an ethylene-based polymer, (ii) linkages of Structure 2 (formed from 2,2,6,6-tetramethyl-4-piperidyl methacrylate disulfide (BiTEMPS methacrylate)), and (iii) optional additive. The process includes heating the coating to a reprocessing temperature. The process includes forming, at the reprocessing temperature, the coating into a re-processable ethylene-based polymer composition. The process includes shaping, at the reprocessing temperature, the re-processable ethylene-based composition into a re-processed pre-form. The process includes cooling the re-processed pre-form to below the reprocessing temperature and forming a second article composed of a re-crosslinked ethylene-based polymer composition composed of (i) the ethylene-based polymer and (ii) linkages of Structure 2 (formed from the BiTEMPS methacrylate).

In an embodiment, the process includes removing the coating from a coated conductor. The removing step occurs before heating to the reprocessing temperature.

In an embodiment, the shaping step is a procedure selected from injection molding, extrusion, extrusion molding, thermoforming, slush molding, over molding, insert molding, blow molding, cast molding, tentering, compression molding, and combinations thereof.

Nonlimiting examples of suitable second articles for the present crosslinked/re-crosslinked ethylene-based polymer (with Structure (2) formed from BiTEMPS methacrylate) composition include coating on a conductor, three-dimensional loop articles; elastic film; elastic fiber; soft touch good, such as tooth brush handles and appliance handles; gaskets and profiles; adhesives (including hot melt adhesives and pressure sensitive adhesives); footwear (including shoe soles and shoe liners); auto interior parts and profiles; foam articles (both open cell foam and closed cell foam); impact modifiers for other thermoplastic polymers such as high density polyethylene, isotactic polypropylene, or other olefin polymers; coated fabrics; hoses; tubing; weather stripping; cap liners; flooring; and combinations thereof.

Applicant discovered that the coating composed of the crosslinked composition of ethylene-based polymer and linkages of Structure 2 (formed from BiTEMPS methacrylate) (and optional additive) is capable of undergoing reversible crosslinking at reprocessing temperatures.

The reversible crosslinking is achieved by forming the coating from a crosslinkable polymer composition composed of ethylene-based polymer, peroxide, BITEMPS methacrylate (and optional additive). The inventive compositions form a coating for conductor composed of the crosslinked composition, wherein the crosslinked composition is crosslinked at application use temperatures (ambient temperature up to 130° C.) but can be melt reprocessed at typical reprocessing temperatures (˜160-250° C.). As a result, the present disclosure offers the benefits of a coating for conductor with heat resistance and durability for wire and cable applications, while maintaining (re) processability under typical extrusion temperatures.

By way of example, and not limitation, some embodiments of the present disclosure will now be described in detail in the following examples.

### 1. Materials

Materials used in the comparative samples (CS) and inventive examples (IE) are provided in Table 1 below.

TABLE 1
Materials used in the inventive examples (″IE″) and comparative samples (″CS)

| Component/Description | Structure/properties | Source |
|---|---|---|
| LDPE #1 | LDPE Ethylene homopolymer | The Dow Chemical |
| | density-0.920 g/cc, MI −1.80 g/10 min | Company |
| Dicumyl Peroxide (″DCP″) | C₁₈H₂₂O₂ | Sigma-Aldrich |
| Radical initiator | | |
| BITEMPS methacrylate | 2,2,6,6-tetramethyl-4-piperidyl methacrylate disulfide | Custom synthesis |
| Reversible crosslinker | (Structure 1) C₂₆H₄₄N₂O₄S₂ | |
| | Structure (1) | |
| | 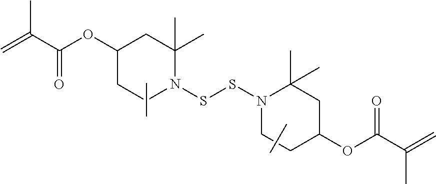 | |
| Antioxidant A | Antioxidant A is a blend consisting of DSTDP (61.58%), | |
| | Cyanox 1790 (37.52%), and Uvinul 4050 (0.90%). | |
| Cyanox 2212 | antioxidant | Solvay USA |

### 2. Synthesis of BITEMPS Methacrylate

To synthesize BiTEMPS methacrylate, 2,2,6,6-tetramethyl-4-piperidyl methacrylate (8.78 g, 39.0 mmol, supplied by TCI America) is first dissolved in anhydrous petroleum ether (˜90 mL, supplied by Sigma-Aldrich, dried over molecular sieves for 48 hr before use) and cooled to −70° C. in a dry ice/acetone bath. Afterward, sulfur monochloride (1.30 g, 9.7 mmol, supplied by Sigma-Aldrich) is dissolved in anhydrous petroleum ether (˜1.25 mL) and added dropwise to the reaction vessel over the course of 30 minutes. The solution is stirred at −70° C. for an additional 30 minutes and at room temperature for 15 minutes. Next, BiTEMPS methacrylate is precipitated out by pouring the reaction solution into copious distilled water and stirring at room temperature overnight. The precipitates are collected, vacuum-filtered, and vacuum-dried at 60° C. for 48 hr to obtain BiTEMPS methacrylate, shown as Structure 1 below.

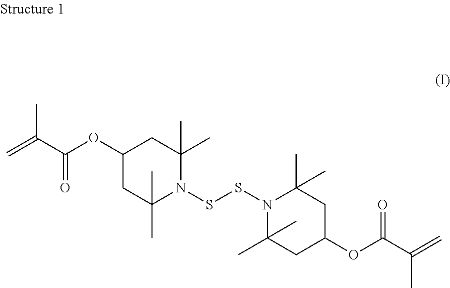

### 3. Formulations

LDPE #1, dicumyl peroxide, BiTEMPS methacrylate, and Antioxidant A were combined (in the amounts shown in Table 2 below) and batch mixed at 120° C. to form crosslinkable polymer compositions. The crosslinkable polymer compositions were heated on an RPA at 180° C. for 30 min to initiate the crosslinking reaction. The properties of the crosslinking reaction are provided in Tables 2A.

Plaques were also made of the crosslinkable polymer compositions by pressing about 35 g portions in a Wabash press. For CS1, pellets were pressed at 120° C. and 500 psi for 5 minutes, cut into pieces, restacked, and repressed again at 120° C. and 500 psi for 5 minutes followed 2500 psi for 5 minutes, and then finally at 180° C. and 2500 psi for 15 minutes to cure the plaques. For all the other examples, single pieces were pressed at 180° C. and 500 psi for 5 minutes followed by 2500 psi for 15 minutes. For electrical testing, the plaques were nominally 50 mil, and for mechanical testing, they were nominally 75 mil replaqued from the original 50 mil plaques (except for CS1 where two separate plaques were made). Electrical data and mechanical data are in Tables 2B and 2C, respectively, below. CS1 and IE1 were degassed following sample preparation, but CS2 and IE2-4 were not degassed.

TABLE 2A
Crosslinked composition of Coating and properties

| | CS1 | IE1 | CS2 | IE2 | IE3 | IE4 |
|---|---|---|---|---|---|---|
| LDPE #1 | 98.06% | 95.00% | 98.52% | 89.28% | 84.75% | 94.34% |
| Antioxidant A | 0.37% | 0.00% | 0.00% | 0.00% | 0.00% | 0.00% |
| Dicumyl Peroxide | 1.57% | 1.00% | 1.48% | 1.79% | 2.54% | 2.83% |
| BiTEMPS-MA | 0.00% | 4.00% | 0.00% | 8.93% | 12.71% | 2.83% |
| | 100% | 100% | 100 wt % | 100 wt % | 100 wt % | 100 wt % |
| RPA S′ @ 180° C., 30 min | — | — | 2.50 | 0.44 | 1.28 | 4.15 |
| (dNm) | | | | | | |
| RPA n* @ 0.1 rad/s, 180° | — | — | 1785941 | 171842 | 580205 | 3133404 |
| C. (Pa-s) | | | | | | |
| RPA n* @ 100 rad/s, 180° | — | — | 3044 | 1075 | 1734 | 3586 |
| C. (Pa-s) | | | | | | |
| RPA tan delta (G′/G″)@ | — | — | 0.09 | 0.872 | 0.71 | 0.103 |
| 0.1 rad/s, 180° C. | | | | | | |
| RPA n* @ 0.1 rad/s, 230° | — | — | 1727915 | 20786 | 57543 | 1652029 |
| C. (Pa-s) | | | | | | |
| RPA n* @ 100 rad/s, 230° | — | — | 2670 | 413 | 507 | 2155 |
| C. (Pa-s) | | | | | | |
| RPA tan delta (G′/G″) @ | — | — | 0.06 | 1.61 | 0.883 | 0.101 |
| 0.1 rad/s, 230° C. | | | | | | |
| Viscosity Reprocessing | — | — | 1.03 | 8.27 | 10.1 | 1.90 |
| Ratio (n0.1*@180° C./ | | | | | | |
| n0.1@230° C.) (VRR) | | | | | | |
| Reprocessable | — | — | No | Yes | Yes | Yes |

TABLE 2B
Table 2B Crosslinked compositions of coating and electrical properties. Samples
CS1 and IE1 were degassed, and the other samples CS2 and IE2-4 were not degassed.

| | Component | CS1 (wt %) | IE1 (wt %) | CS2 (wt %) | IE2 (wt %) | IE3 (wt %) | IE4 (wt %) |
|---|---|---|---|---|---|---|---|
| | LDPE #1 | 98.06% | 95.00% | 98.52% | 89.28% | 84.75% | 94.34% |
| | Antioxidant A | 0.37% | 0.00% | 0.00% | 0.00% | 0.00% | 0.00% |
| | Dicumyl Peroxide | 1.57% | 1.00% | 1.48% | 1.79% | 2.54% | 2.83% |
| | BITEMPS-MA | 0.00% | 4.00% | 0.00% | 8.93% | 12.71% | 2.83% |
| | | 100 wt % | 100 wt % | 100 wt % | 100 wt % | 100 wt % | 100 wt % |
| Volume | Temp (° | 1.55 × 10¹⁷ | 3.27 × 10¹⁷ | 3.59 × 10¹⁴ | 1.60 × 10¹⁶ | 4.12 × 10¹⁵ | 6.80 × 10¹⁵ |
| Resistivity | C.) 23 | | | | | | |
| (ohm/cm) | | | | | | | |
| Dielectric | 23 | 2.2744 | 2.3636 | 2.3331 | 2.4859 | 2.6309 | 2.5161 |
| Constant | | | | | | | |
| | 70 | 2.156 | 2.2333 | 2.2159 | 2.3367 | 2.4533 | 2.3264 |
| | 90 | 1.9972 | 2.0226 | 2.0536 | 2.1776 | 2.2095 | 2.1635 |
| | 110 | 1.8457 | 1.8846 | 1.8383 | 1.9678 | 2.0116 | 1.9632 |
| | 130 | 1.7435 | 1.8675 | | | | |
| Dissipation | 23 | 0.0001 | 0.0008 | 0.0002 | 0.0027 | 0.0053 | 0.0010 |
| Factor (radians) | | | | | | | |
| | 70 | 0.0000 | 0.0001 | 0.0001 | 0.0016 | 0.0045 | 0.0005 |
| | 90 | 0.0000 | 0.0003 | 0.0001 | 0.0013 | 0.0028 | 0.0006 |
| | 110 | 0.0001 | 0.0012 | 0.0003 | 0.0016 | 0.0021 | 0.0007 |
| | 130 | 0.0002 | 0.0039 | | | | |

TABLE 3A
Mechanical data for coatings

| Frequency | Temp | CS-1 | | | IE-1 | | | CS-2 | | |
|---|---|---|---|---|---|---|---|---|---|---|
| (rad/s) | (° C.) | G′ (Pa) | G″ (Pa) | tan δ | G′ (Pa) | G″ (Pa) | tan δ | G′(Pa) | G″ (Pa) | tan δ |
| 1.00E+02 | 130 | 2.73E+05 | 4.81E+04 | 0.18 | 1.46E+05 | 6.33E+04 | 0.43 | 1.59E+05 | 2.95E+04 | 0.19 |
| 6.31E+01 | 130 | 2.59E+05 | 4.49E+04 | 0.17 | 1.29E+05 | 5.65E+04 | 0.44 | 1.50E+05 | 2.77E+04 | 0.19 |
| 3.98E+01 | 130 | 2.47E+05 | 4.09E+04 | 0.17 | 1.14E+05 | 5.07E+04 | 0.44 | 1.40E+05 | 2.56E+04 | 0.18 |
| 2.51E+01 | 130 | 2.35E+05 | 3.77E+04 | 0.16 | 1.00E+05 | 4.52E+04 | 0.45 | 1.32E+05 | 2.38E+04 | 0.18 |
| 1.59E+01 | 130 | 2.25E+05 | 3.49E+04 | 0.15 | 8.84E+04 | 4.04E+04 | 0.46 | 1.25E+05 | 2.22E+04 | 0.18 |
| 1.00E+01 | 130 | 2.15E+05 | 3.20E+04 | 0.15 | 7.77E+04 | 3.59E+04 | 0.46 | 1.18E+05 | 2.07E+04 | 0.18 |
| 6.31E+00 | 130 | 2.06E+05 | 2.98E+04 | 0.14 | 6.83E+04 | 3.19E+04 | 0.47 | 1.12E+05 | 1.94E+04 | 0.17 |
| 3.98E+00 | 130 | 1.98E+05 | 2.77E+04 | 0.14 | 5.97E+04 | 2.84E+04 | 0.48 | 1.06E+05 | 1.80E+04 | 0.17 |
| 2.51E+00 | 130 | 1.90E+05 | 2.53E+04 | 0.13 | 5.23E+04 | 2.52E+04 | 0.48 | 1.00E+05 | 1.69E+04 | 0.17 |
| 1.59E+00 | 130 | 1.83E+05 | 2.32E+04 | 0.13 | 4.55E+04 | 2.22E+04 | 0.49 | 9.54E+04 | 1.54E+04 | 0.16 |
| 1.00E+00 | 130 | 1.77E+05 | 2.17E+04 | 0.12 | 3.99E+04 | 1.97E+04 | 0.49 | 9.18E+04 | 1.48E+04 | 0.16 |
| 6.31E−01 | 130 | 1.71E+05 | 1.97E+04 | 0.12 | 3.47E+04 | 1.74E+04 | 0.50 | 8.71E+04 | 1.36E+04 | 0.16 |
| 3.98E−01 | 130 | 1.65E+05 | 1.83E+04 | 0.11 | 3.02E+04 | 1.54E+04 | 0.51 | 8.29E+04 | 1.29E+04 | 0.16 |
| 2.51E−01 | 130 | 1.61E+05 | 1.60E+04 | 0.10 | 2.62E+04 | 1.36E+04 | 0.52 | 7.89E+04 | 1.16E+04 | 0.15 |
| 1.59E−01 | 130 | 1.56E+05 | 1.65E+04 | 0.11 | 2.28E+04 | 1.19E+04 | 0.52 | 7.63E+04 | 1.09E+04 | 0.14 |
| 1.00E−01 | 130 | 1.50E+05 | 1.47E+04 | 0.10 | 1.98E+04 | 1.06E+04 | 0.54 | 7.49E+04 | 9.51E+03 | 0.13 |
| Frequency | Temp | IE-2 | | | IE-3 | | | IE-4 | | |
| (rad/s) | (° C.) | G′ (Pa) | G″ (Pa) | tan δ | G′ (Pa) | G″ (Pa) | tan δ | G′ (Pa) | G″ (Pa) | tan δ |
| 1.00E+02 | 130 | 1.51E+05 | 5.29E+04 | 0.35 | 1.66E+05 | 4.51E+04 | 0.27 | 2.94E+05 | 3.98E+04 | 0.14 |
| 6.31E+01 | 130 | 1.37E+05 | 4.80E+04 | 0.35 | 1.55E+05 | 4.11E+04 | 0.27 | 2.83E+05 | 3.61E+04 | 0.13 |
| 3.98E+01 | 130 | 1.24E+05 | 4.32E+04 | 0.35 | 1.44E+05 | 3.74E+04 | 0.26 | 2.73E+05 | 3.25E+04 | 0.12 |
| 2.51E+01 | 130 | 1.13E+05 | 3.90E+04 | 0.35 | 1.34E+05 | 3.43E+04 | 0.26 | 2.64E+05 | 2.92E+04 | 0.11 |
| 1.59E+01 | 130 | 1.02E+05 | 3.52E+04 | 0.34 | 1.25E+05 | 3.12E+04 | 0.25 | 2.57E+05 | 2.63E+04 | 0.10 |
| 1.00E+01 | 130 | 9.28E+04 | 3.18E+04 | 0.34 | 1.17E+05 | 2.85E+04 | 0.24 | 2.50E+05 | 2.38E+04 | 0.10 |
| 6.31E+00 | 130 | 8.44E+04 | 2.86E+04 | 0.34 | 1.09E+05 | 2.63E+04 | 0.24 | 2.43E+05 | 2.15E+04 | 0.09 |
| 3.98E+00 | 130 | 7.66E+04 | 2.61E+04 | 0.34 | 1.02E+05 | 2.44E+04 | 0.24 | 2.37E+05 | 1.94E+04 | 0.08 |
| 2.51E+00 | 130 | 6.99E+04 | 2.36E+04 | 0.34 | 9.56E+04 | 2.26E+04 | 0.24 | 2.32E+05 | 1.76E+04 | 0.08 |
| 1.59E+00 | 130 | 6.36E+04 | 2.12E+04 | 0.33 | 8.97E+04 | 2.11E+04 | 0.24 | 2.27E+05 | 1.59E+04 | 0.07 |
| 1.00E+00 | 130 | 5.79E+04 | 1.93E+04 | 0.33 | 8.43E+04 | 2.01E+04 | 0.24 | 2.23E+05 | 1.44E+04 | 0.06 |
| 6.31E−01 | 130 | 5.28E+04 | 1.75E+04 | 0.33 | 7.93E+04 | 1.92E+04 | 0.24 | 2.19E+05 | 1.32E+04 | 0.06 |
| 3.98E−01 | 130 | 4.82E+04 | 1.59E+04 | 0.33 | 7.46E+04 | 1.87E+04 | 0.25 | 2.16E+05 | 1.17E+04 | 0.05 |
| 2.51E−01 | 130 | 4.40E+04 | 1.48E+04 | 0.34 | 7.00E+04 | 1.79E+04 | 0.26 | 2.13E+05 | 1.11E+04 | 0.05 |
| 1.59E−01 | 130 | 4.03E+04 | 1.38E+04 | 0.34 | 6.54E+04 | 1.81E+04 | 0.28 | 2.09E+05 | 1.00E+04 | 0.05 |
| 1.00E−01 | 130 | 3.69E+04 | 1.30E+04 | 0.35 | 6.19E+04 | 1.91E+04 | 0.31 | 2.07E+05 | 8.01E+03 | 0.04 |

TABLE 3B
Mechanical data for coatings

| Frequency | Temp | CS1 | | | IE1 | | | CS2 | | |
|---|---|---|---|---|---|---|---|---|---|---|
| (rad/s) | (° C.) | G′ (Pa) | G″ (Pa) | tan δ | G′ (Pa) | G″ (Pa) | tan δ | G′ (Pa) | G″ (Pa) | tan δ |
| 1.00E+02 | 180 | 2.09E+05 | 2.71E+04 | 0.13 | 9.96E+04 | 4.93E+04 | 0.49 | 3.85E+05 | 9.22E+04 | 0.24 |
| 6.31E+01 | 180 | 2.01E+05 | 2.44E+04 | 0.12 | 8.69E+04 | 4.35E+04 | 0.50 | 3.59E+05 | 7.56E+04 | 0.21 |
| 3.98E+01 | 180 | 1.92E+05 | 2.21E+04 | 0.11 | 7.57E+04 | 3.83E+04 | 0.51 | 3.44E+05 | 6.68E+04 | 0.19 |
| 2.51E+01 | 180 | 1.85E+05 | 2.02E+04 | 0.11 | 6.57E+04 | 3.37E+04 | 0.51 | 3.27E+05 | 6.08E+04 | 0.19 |
| 1.59E+01 | 180 | 1.77E+05 | 1.83E+04 | 0.10 | 5.69E+04 | 2.97E+04 | 0.52 | 3.10E+05 | 5.46E+04 | 0.18 |
| 1.00E+01 | 180 | 1.70E+05 | 1.67E+04 | 0.10 | 4.93E+04 | 2.61E+04 | 0.53 | 2.97E+05 | 4.93E+04 | 0.17 |
| 6.31E+00 | 180 | 1.65E+05 | 1.53E+04 | 0.09 | 4.26E+04 | 2.30E+04 | 0.54 | 2.81E+05 | 4.64E+04 | 0.17 |
| 3.98E+00 | 180 | 1.59E+05 | 1.38E+04 | 0.09 | 3.66E+04 | 2.03E+04 | 0.55 | 2.69E+05 | 4.50E+04 | 0.17 |
| 2.51E+00 | 180 | 1.54E+05 | 1.22E+04 | 0.08 | 3.15E+04 | 1.80E+04 | 0.57 | 2.60E+05 | 4.14E+04 | 0.16 |
| 1.59E+00 | 180 | 1.49E+05 | 1.11E+04 | 0.07 | 2.69E+04 | 1.60E+04 | 0.59 | 2.45E+05 | 3.83E+04 | 0.16 |
| 1.00E+00 | 180 | 1.45E+05 | 9.58E+03 | 0.07 | 2.27E+04 | 1.45E+04 | 0.64 | 2.33E+05 | 3.51E+04 | 0.15 |
| 6.31E−01 | 180 | 1.42E+05 | 7.22E+03 | 0.05 | 1.90E+04 | 1.30E+04 | 0.68 | | | |
| 3.98E−01 | 180 | 1.40E+05 | 8.56E+03 | 0.06 | 1.53E+04 | 1.17E+04 | 0.76 | | | |
| 2.51E−01 | 180 | 1.39E+05 | 4.82E+03 | 0.03 | 1.20E+04 | 1.04E+04 | 0.87 | | | |
| 1.59E−01 | 180 | 1.36E+05 | 4.25E+03 | 0.03 | 9.15E+03 | 9.08E+03 | 0.99 | | | |
| 1.00E−01 | 180 | 1.31E+05 | 3.51E+03 | 0.03 | 6.63E+03 | 7.63E+03 | 1.15 | | | |
| Frequency | Temp | IE2 | | | IE3 | | | IE4 | | |
| (rad/s) | (° C.) | G′ (Pa) | G″ (Pa) | tan δ | G′ (Pa) | G″ (Pa) | tan δ | G′ (Pa) | G″ (Pa) | tan δ |
| 1.00E+02 | 180 | 1.33E+05 | 4.78E+04 | 0.36 | 1.36E+05 | 3.96E+04 | 0.29 | 2.69E+05 | 2.09E+04 | 0.08 |
| 6.31E+01 | 180 | 1.20E+05 | 4.28E+04 | 0.36 | 1.26E+05 | 3.57E+04 | 0.28 | 2.61E+05 | 1.85E+04 | 0.07 |
| 3.98E+01 | 180 | 1.09E+05 | 3.83E+04 | 0.35 | 1.16E+05 | 3.21E+04 | 0.28 | 2.54E+05 | 1.54E+04 | 0.06 |
| 2.51E+01 | 180 | 9.91E+04 | 3.43E+04 | 0.35 | 1.08E+05 | 2.90E+04 | 0.27 | 2.47E+05 | 1.26E+04 | 0.05 |
| 1.59E+01 | 180 | 9.01E+04 | 3.10E+04 | 0.34 | 1.01E+05 | 2.65E+04 | 0.26 | 2.41E+05 | 1.06E+04 | 0.04 |
| 1.00E+01 | 180 | 8.22E+04 | 2.83E+04 | 0.34 | 9.39E+04 | 2.47E+04 | 0.26 | 2.36E+05 | 8.74E+03 | 0.04 |
| 6.31E+00 | 180 | 7.50E+04 | 2.60E+04 | 0.35 | 8.76E+04 | 2.34E+04 | 0.27 | 2.31E+05 | 7.59E+03 | 0.03 |
| 3.98E+00 | 180 | 6.83E+04 | 2.43E+04 | 0.36 | 8.16E+04 | 2.28E+04 | 0.28 | 2.26E+05 | 6.45E+03 | 0.03 |
| 2.51E+00 | 180 | 6.20E+04 | 2.32E+04 | 0.37 | 7.54E+04 | 2.31E+04 | 0.31 | 2.23E+05 | 5.57E+03 | 0.03 |
| 1.59E+00 | 180 | 5.57E+04 | 2.28E+04 | 0.41 | 6.91E+04 | 2.40E+04 | 0.35 | 2.18E+05 | 5.20E+03 | 0.02 |
| 1.00E+00 | 180 | 4.92E+04 | 2.26E+04 | 0.46 | 6.18E+04 | 2.55E+04 | 0.41 | 2.15E+05 | 4.68E+03 | 0.02 |
| 6.31E−01 | 180 | 4.25E+04 | 2.26E+04 | 0.53 | 5.37E+04 | 2.62E+04 | 0.49 | 2.11E+05 | 5.69E+03 | 0.03 |
| 3.98E−01 | 180 | 3.54E+04 | 2.21E+04 | 0.62 | 4.48E+04 | 2.63E+04 | 0.59 | 2.08E+05 | 6.89E+03 | 0.03 |
| 2.51E−01 | 180 | 2.83E+04 | 2.09E+04 | 0.74 | 3.60E+04 | 2.53E+04 | 0.70 | 2.03E+05 | 9.46E+03 | 0.05 |
| 1.59E−01 | 180 | 2.17E+04 | 1.88E+04 | 0.87 | 2.77E+04 | 2.27E+04 | 0.82 | 1.98E+05 | 1.25E+04 | 0.06 |
| 1.00E−01 | 180 | 1.60E+04 | 1.62E+04 | 1.01 | 2.08E+04 | 1.98E+04 | 0.95 | 1.91E+05 | 1.60E+04 | 0.08 |

As is shown in Tables 2B, 3A, and 3B, the electrical properties for the Inventive Examples and Comparative Samples are similar. The degassed volume resistivity (higher is better) for Inventive Example 1 is higher than that of Comparative Sample 1, though both are very high and of the same order of magnitude. For the other examples, they were not degassed, so all of their resistivities are lower. Nonetheless, the non-degassed volume resistivity for Inventive Examples 2-4 is higher than the volume resistivity for Comparative Sample 2.

The dielectric constant (lower is better) and dissipation factor (lower is better) for the Inventive Examples 1˜4 each is very low and acceptable for wire and cable applications. Noteworthy is that the dielectric constant and the dissipation factor for IE 1-4 are similar to, or substantially similar to, the dielectric constant and the dissipation factor values for CS 1-2. However, the coating for each of IE 1-4 is re-processable, whereas the coating for each of CS-1 and CS-2 is permanently crosslinked and is not re-processable, as shown in the mechanical data.

In particular, all of the tan δ values for CS-1 and CS-2 are well below unity (well below 1), signifying a permanently crosslinked material, whereas most of the tan δ values for Inventive Examples 1-3 are well below unity, except for those at 180° C. and low frequency, signifying a transition to a flowable material. Inventive Example 4 has a higher crosslink density, so the tan δ is low under all test conditions; however, these measurements were still made on a plaque that was repressed, signifying its ability for reprocessing.

It is specifically intended that the present disclosure not be limited to the embodiments and illustrations contained herein, but include modified forms of those embodiments including portions of the embodiments and combination of elements of different embodiments as come within the scope of the following claims.

1. A coated conductor comprising:
a conductor; and
a coating on the conductor, the coating composed of a crosslinked composition formed from starting materials comprising
an ethylene-based polymer; and
2,2,6,6-tetramethyl-4-piperidyl methacrylate disulfide (BiTEMPS methacrylate).

2. The coated conductor of claim 1 wherein the crosslinked composition comprises linkages of Structure 2

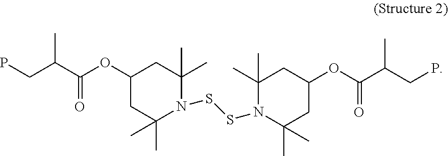

3. The coated conductor of claim 1 wherein the crosslinked composition is formed from the starting materials comprising
from 80 wt % to 99 wt % of an ethylene-based polymer having a melt index from 0.1 g/10 min to 100 g/10 min; and
from 20 wt % to 1 wt % of the BiTEMPS methacrylate.

4. The coated conductor of claim 1 wherein the ethylene-based polymer is a low density polyethylene (LDPE).

5. The coated conductor of claim 4 wherein the LDPE has a property selected from the group consisting of
(i) a density from 0.910 g/cc to 0.940 g/cc,
(ii) a melt index from 0.1 g/10 min to 100 g/10 min, and
(iii) combinations thereof.

6. The coated conductor of claim 1 comprising an additive, the additive selected from the group consisting of carbon black, antioxidant, stabilizer, processing aid, and combinations thereof.

7. The coated conductor of claim 1 wherein the crosslinked composition is formed from starting materials comprising
(i) from 80 wt % to 99 wt % of the ethylene-based polymer;
(ii) from 1 wt % to 15 wt % of the BiTEMPS methacrylate;
(iii) from 0 wt % to 0.5 wt % of a free radical initiator.

8. The coated conductor of claim 7 wherein the crosslinked composition has a property selected from the group consisting of
(i) a degassed volume resistivity at 23° C. from 10¹⁶ ohm/cm to 10²⁰ ohm/cm,
(ii) a non-degassed volume resistivity at 23° C. from 10¹⁵ ohm/cm to 10²⁰ ohm/cm,
(iii) a dielectric constant at 23° C. from 2.20 to 2.70,
(iv) a dielectric constant at 110° C. from 1.80 to 2.10,
(v) a dissipation factor at 23° C. and 60 Hz from 0.0001 radians to 0.01 radians,
(vi) a dissipation factor at 110° C. and 60 Hz from 0.0001 radians to 0.01 radians, and/or
(vii) a G′ at 130° C. and 100 rad/s from 10⁵ Pa to 10⁷ Pa,
(viii) a G′ at 130° C. and 100 rad/s from 10⁴ Pa to 10⁷ Pa,
(ix) a tan delta at 130° C. from 0 to 0.6, and
(x) combinations thereof.

9. A coated conductor comprising:
a conductor; and
a coating on the conductor, the coating composed of a crosslinked composition comprising
an ethylene-based polymer; and
linkages having a Structure (2)

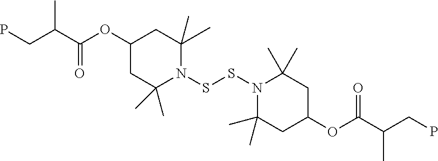

10. A process comprising:
providing a coating from a coating conductor, the coating composed of a crosslinked composition composed of
(i) an ethylene-based polymer, and
(ii) linkages having a Structure (2) 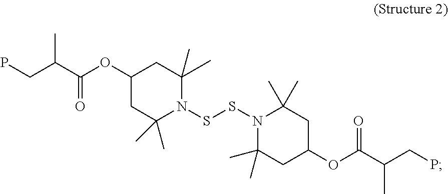
heating the coating to a reprocessing temperature;
forming, at the reprocessing temperature, the coating into a re-processable ethylene-based polymer composition;
shaping, at the reprocessing temperature, the re-processable ethylene-based composition into a re-processed pre-form; and
cooling the re-processed pre-form to below the reprocessing temperature and forming a second article composed of a re-crosslinked ethylene-based polymer composition composed of (i) the ethylene-based polymer and (ii) linkages having the Structure (2).

11. The process of claim 10 comprising
removing from the coating from a coated conductor.
